(19) United States
(12) Patent Application Publication
(10) Pub. No.: US 2025/0355764 A1
(43) Pub. Date: Nov. 20, 2025

(54) POPULATION-BASED MEDIA SCAN

(71) Applicant: Micron Technology, Inc., Boise, ID (US)

(72) Inventors: Dongxiang Liao, Cupertino, CA (US); Daniel Zhang, Milpitas, CA (US); Li-Te Chang, San Jose, CA (US); John Slattery, Louisville, CO (US); Aaron Lee, Sunnyvale, CA (US)

(21) Appl. No.: 19/202,907

(22) Filed: May 8, 2025

Related U.S. Application Data
(60) Provisional application No. 63/647,387, filed on May 14, 2024.

(51) Int. Cl. G06F 11/10

(52) U.S. Cl. CPC G06F 11/1016; G06F 11/1048

(57) ABSTRACT

The present disclosure configures a system component, such as a memory sub-system controller, to provide adaptive media management based on bit error rates. The controller receives a request to read data from an individual memory component of a set of memory components and, in response to receiving the request to read the data, reads the data from the individual memory component. The controller computes a number of errors associated with reading the data from the individual memory component. The controller determines whether the number of errors satisfies a refresh condition and selectively refreshes the data stored in the individual memory component based on whether the number of errors satisfies the refresh condition.

### PRIORITY APPLICATION

This application claims the benefit of priority to U.S. Provisional Application Ser. No. 63/647,387, filed May 14, 2024, which is incorporated herein by reference in its entirety.

### TECHNICAL FIELD

Examples of the disclosure relate generally to memory sub-systems and, more specifically, to providing media management for memory components, such as memory dies or memory blocks.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment including a memory sub-system, in accordance with some examples.

FIG. 2 is a block diagram of an example media operations manager, in accordance with some examples.

FIG. 3 is a block diagram of an example block stripe, in accordance with some examples.

FIGS. 4-5 are flow diagrams of example methods to perform media management operations, in accordance with some examples.

FIG. 6 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

The present disclosure configures a system component, such as a memory sub-system controller, to perform memory management operations on different groups of memory components (e.g., memory dies, planes, word lines, and/or memory blocks or sub-blocks) based on their respective bit error counts. The memory sub-system controller can select a block stripe from which to read data to determine whether the block stripe needs to be refreshed or folded. The memory sub-system controller can read the data from individual portions (e.g., pages) of the block stripe, one at a time. As the data is read, the memory sub-system controller counts the number of bit errors associated with each portion being read. If the number of bit errors associated with reading an individual portion transgresses a threshold, the memory sub-system controller updates a count representing the number of codewords in the portion having uncorrectable errors or having a number of bit errors that transgresses the threshold. The memory sub-system controller also increments a first count associated with the number of errors encountered in reading the block stripe and a second count for the memory component in which the portion of the block stripe with the errors is stored. After reading the data from each portion of the block stripe, the memory sub-system controller selectively folds or refreshes the block stripe if either the first or the second count transgresses a respective threshold.

This enables the controller to dynamically control the frequency at which refresh operations or folding operations are performed for each block stripe, which improves the overall efficiency of operating the memory sub-system. Namely, rather than folding or refreshing the block stripe each time a bit error count transgresses a threshold, the memory sub-system controller can fold or refresh the data on the basis of whether multiple portions have bit error counts or uncorrectable errors that transgress a threshold to avoid having to perform refresh or folding operations when not necessary.

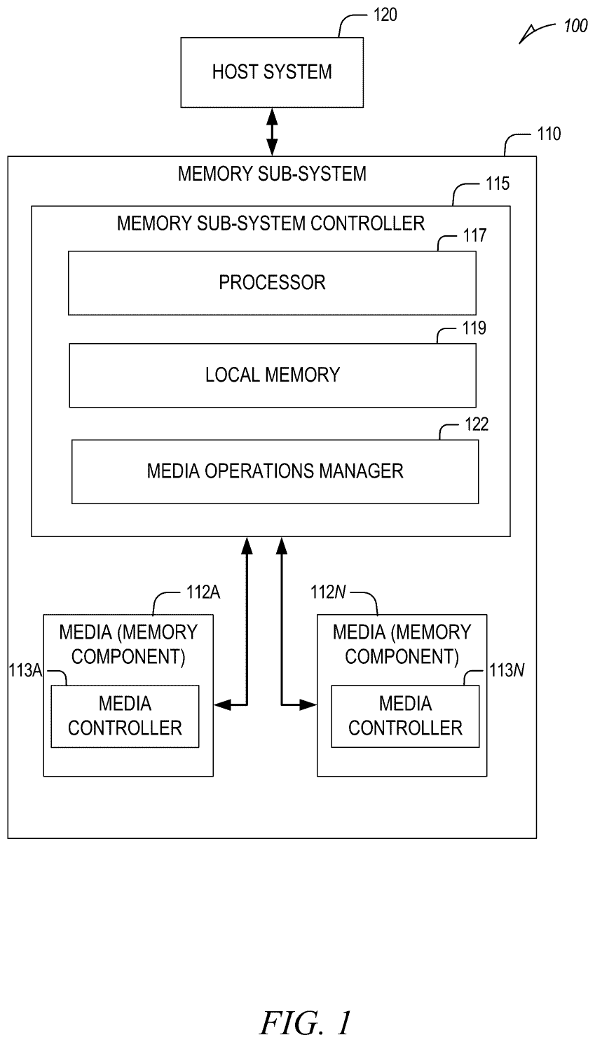

A memory sub-system can be a storage device, a memory module, or a hybrid of a storage device and memory module. Examples of storage devices and memory modules are described below in conjunction with FIG. 1 In general, a host system can utilize a memory sub-system that includes one or more memory components, such as memory devices (e.g., memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data”.

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data” and can be performed periodically for each block stripe (BS) that is stored in the memory sub-system. “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management (e.g., read disturb scan operations), different near miss error correction code (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package.

There are challenges in efficiently managing or performing media management operations on typical memory devices. Specifically, in NAND flash memory systems, a common practice to maintain data integrity involves periodically scanning the memory for errors and refreshing the data when necessary. This process is typically triggered when the bit error rate (BER) of a portion (e.g., a page) of a block stripe stored in the memory exceeds a predefined threshold. However, this approach can lead to inefficiencies and a waste of resources. When a single portion or word line (WL) within a larger block or block stripe exceeds the BER threshold, the entire block stripe may be refreshed, even though other portions may not have reached the threshold and do not require refreshing. This can result in unnecessary read and write operations, which consume additional time and power, and also contribute to the wear and tear of the memory cells.

Moreover, these operations can negatively impact the overall performance and lifespan of the NAND system. Since NAND flash memory has a limited number of program-erase cycles, unnecessary refresh operations can prematurely exhaust the endurance of the memory cells. This inefficiency is compounded by the fact that different memory cells may have varying levels of tolerance to temperature changes and wear, meaning that a one-size-fits-all approach to error management can lead to over-provisioning of maintenance operations. Consequently, the system may spend excessive resources on maintaining memory cells that do not yet require intervention, leading to a suboptimal use of the memory system's capabilities and a reduction in the efficiency of the storage device.

The present disclosure addresses the above and other deficiencies by providing a memory controller that can dynamically control whether refresh or folding operations are performed for a block stripe based on error counts associated with multiple portions of the block stripe. The memory sub-system controller can select a block stripe from which to read data to determine whether the block stripe needs to be refreshed or folded. The memory sub-system controller can read the data from individual portions (e.g., pages) of the block stripe, one at a time. As the data is read, the memory sub-system controller counts the number of bit errors associated with each portion being read. If the number of bit errors associated with reading an individual portion transgresses a threshold, the memory sub-system controller updates a count representing number of codewords in the portion having uncorrectable errors or having a number of bit errors that transgresses the threshold. The memory sub-system controller also increments a first count associated with the number of errors encountered in reading the block stripe and a second count for the memory component in which the portion of the block stripe with the errors is stored. After reading the data from each portion of the block stripe, the memory sub-system controller selectively folds or refreshes the block stripe if either the first or the second count transgresses a respective threshold (e.g., if the first count transgresses a first threshold and/or if the second count transgresses a second threshold).

For some examples, the memory sub-system (e.g., memory sub-system controller) receives a request to read data from an individual memory component of the set of memory components. The controller, in response to receiving the request to read the data, reads the data from the individual memory component and computes a number of errors associated with reading the data from the individual memory component. The controller determines whether the number of errors satisfies a refresh condition and selectively refreshes the data stored in the individual memory component based on whether the number of errors satisfies the refresh condition.

In some examples, the controller reads the data from a first portion of an individual stripe stored across a plurality of memory components of the set of memory components. The controller stores a first count representing a total number of errors in the data stored across the individual stripe. The controller stores a second count representing a total number of errors associated with each memory component of the set of memory components.

The controller can determine that one or more errors of the number of errors associated with reading the data occurred in the first portion of the individual stripe stored in a first memory component of the set of memory components. The controller, in response to determining that the one or more errors occurred in the first portion of the individual stripe stored in the first memory component of the set of memory components, increments the second count. The controller can compute how many codewords in the first portion is associated with a bit error count that transgresses a bit error count threshold or have uncorrectable errors. The controller increments the first count based on a quantity of the codewords in the first portion that is associated with the bit error count that transgresses the bit error count threshold or have uncorrectable errors.

In some examples, the controller determines whether all portions of the individual stripe have been read. The controller, in response to determining that less than all portions of the individual stripe have been read, reads data from a second portion of the individual stripe. In some cases, the controller updates the first count and the second count based on a quantity of errors that transgresses an error threshold associated with reading data from a second portion of the individual stripe. The controller can determine that all portions of the individual stripe have been read. In such cases, the controller determines that the second count transgresses a die count threshold in response to determining that all portions of the individual stripe have been read. The controller, in response to determining that the second count transgresses the die count threshold, determines that the refresh condition has been satisfied.

In some cases, the controller refreshes the data stored in the individual memory component in response to determining that the refresh condition has been satisfied. The controller determines that the first count transgresses a stripe count threshold; and in response to determining that the first count transgresses the stripe count threshold, determining that the refresh condition has been satisfied. In some examples, the controller refreshes the data stored in the individual memory component in response to determining that the refresh condition has been satisfied.

The number of errors can represent a bit error count associated with one or more portions of the data stored in the individual memory component. The number of errors can represent an uncorrectable bit error associated with one or more portions of the data stored in the individual memory component. The controller can prevent refreshing the data stored in the individual memory component in response to determining that the number of errors fails to satisfy the refresh condition. In some cases, refreshing the data includes folding the data.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies).

In some examples, the first memory component 112A or group of memory components including the first memory component 112A can be associated with a first temperature threshold (or tolerance) and/or reliability (capability) grade, value or measure. Reliability grade, value or measure is used interchangeably throughout and can have the same meaning. Temperature threshold and temperature tolerance measure is used interchangeably throughout and can have the same meaning. The second memory component 112N or group of memory components including the second memory component 112N can be associated with a second temperature threshold and/or reliability (capability) grade, value or measure. In some examples, each memory component 112A to 112N can store respective configuration data that specifies the respective temperature threshold. In some examples, a memory or register can be associated with all of the memory components 112A to 112N which can store a table that maps different groups, bins or sets of the memory components 112A to 112N to respective temperature thresholds. In some examples, each of the memory components 112A to 112N can store a write temperature that has been measured when data was written to the respective memory component 112A to 112N. This data can be stored in a separate write temperature register of each memory component 112A to 112N and/or as part of the underlying data stored to the respective memory component 112A to 112N.

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The memory components 112A to 112N can include any combination of the different types of non-volatile memory components and/or volatile memory components. An example of non-volatile memory components includes NOR- and (NAND)-type flash memory. Each of the memory components 112A to 112N can include one or more arrays of memory cells such as single-level cells (SLCs) or multi-level cells (MLCs) (e.g., TLCs or QLCs). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory.

In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), (NOR) flash memory, electrically erasable programmable read-only memory (EEPROM), and a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages, WLs, planes, blocks, or sub-blocks that can refer to a unit of the memory component 112 used to store data. In general, the memory pages, WLs, sub-blocks, and/or blocks are collectively or individually referred to as memory components.

The memory sub-system controller 115 can communicate with the memory components 112A to 112N to perform operations such as reading data, writing data, or erasing data at the memory components 112A to 112N and other such operations. The memory sub-system controller 115 can communicate with the memory components 112A to 112N to perform various memory management operations, such as different scan rates, different scan frequencies, different wear leveling, different read disturb management operations, such as read disturb scan operations, different near miss ECC operations, folding operations, preventing folding operations from being performed, and/or different dynamic data refresh operations.

The memory sub-system controller 115 can include hardware such as one or more integrated circuits and/or discrete components, one or more thermometers (used to measure a current operating temperature of the memory sub-system 110 and/or the memory components 112A to 112N or ambient temperature), a buffer memory, and/or a combination thereof. In some examples, the output of the one or more thermometers can be used to determine a current write temperature to be stored in association with data on the memory components 112A to 112N.

The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another example, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112N to 112N. The configuration data can include a table that specifies per die error count threshold values and/or block stripe threshold values that each control whether a block stripe is refreshed when a certain number of bit errors are encountered during a media scan operation that reads the block stripe. The configuration data can define different refresh conditions or criteria, such as the different block stripe thresholds and per die error count thresholds that are used to control execution and triggering of refresh or folding operations for different memory components 112A to 112N (e.g., block stripes).

The memory sub-system controller 115 can be responsible for other memory management operations, such as wear leveling operations, garbage collection operations, error detection and error-correcting code (ECC) operations, encryption operations, caching operations, media scans (where different block stripes are read and analyzed for errors to determine whether to refresh or fold the block stripe), data refreshing, read disturb operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

The memory sub-system controller 115 can include a media operations manager 122. The media operations manager 122 can be configured to receive a request to read data from an individual memory component of a set of memory components (e.g., as part of a media scan for one or more block stripes) and, in response to receiving the request to read the data, the media operations manager 122 reads the data from the individual memory component. The media operations manager 122 computes a number of errors associated with reading the data from the individual memory component. The media operations manager 122 determines whether the number of errors satisfies a refresh condition (e.g., whether a number of bit error counts for a die and/or for the entire block stripe transgress respective per die error count thresholds and/or block stripe thresholds) and selectively refreshes the data stored in the individual memory component based on whether the number of errors satisfies the refresh condition.

Depending on the examples, the media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein. Further details with regards to the operations of the media operations manager 122 are described below.

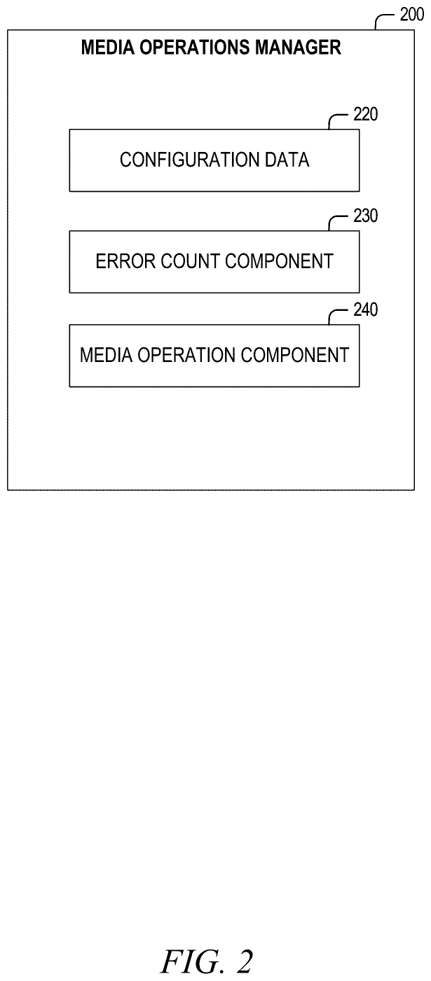

FIG. 2 is a block diagram of an example media operations manager 200 (corresponding to media operations manager 122), in accordance with some examples. As illustrated, the media operations manager 200 includes configuration data 220, an error count component 230, and a media operation component 240. For some examples, the media operations manager 122 can differ in components or arrangement (e.g., less or fewer components) from what is illustrated in FIG. 2

The configuration data 220 accesses and/or stores configuration data associated with the memory components 112A to 112N. In some examples, the configuration data 220 is programmed into the media operations manager 122. For example, the media operations manager 122 can communicate with the memory components 112A to 112N to obtain the configuration data and store the configuration data 220 locally on the media operations manager 122. In some examples, the media operations manager 122 communicates with the host system 120. The host system 120 receives input from an operator or user that specifies parameters including per die error count thresholds and/or block stripe thresholds for different bins, groups, blocks, WLs, memory dies, and/or sets of the memory components 112A to 112N. The media operations manager 122 receives the configuration data from the host system 120 and stores the configuration data in the configuration data 220.

The media operation component 240 can determine that a condition for performing a media scan has been met. For example, the media operation component 240 can periodically perform a media scan of one or more block stripes, such as every 30 minutes. In some cases, the media operation component 240 can perform a media scan for different block stripes at different intervals based on temperature, reliability values, and/or amount of time that has elapsed since the block stripes were erased, read, and/or programmed. The media operation component 240 can select an individual block stripe stored on the set of memory components 112A to 112N for performing a media scan.

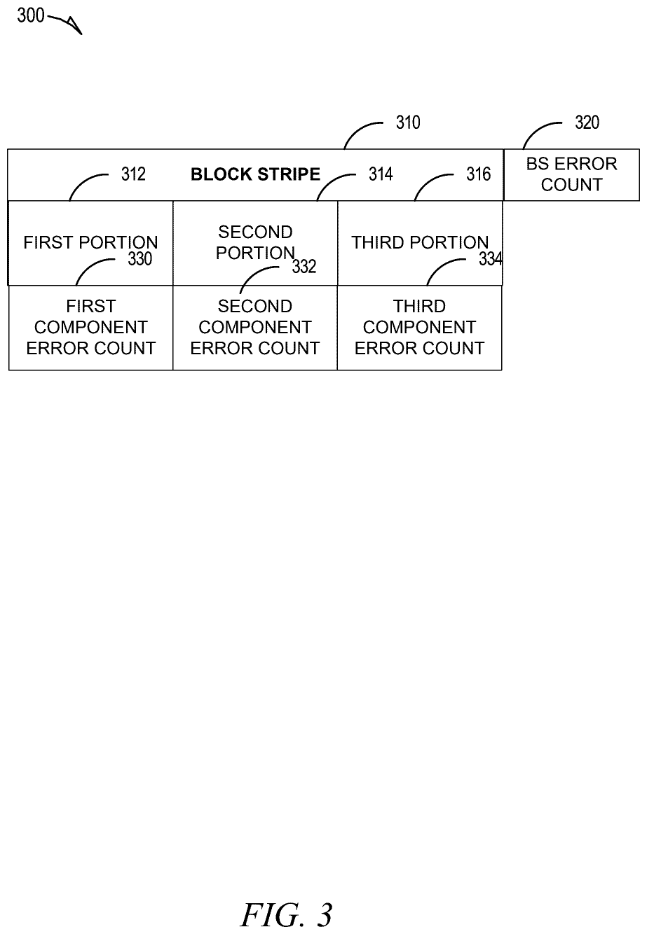

The media operation component 240 can access the individual block stripe, such as the block stripe 310 shown in the diagram 300 of FIG. 3. In some cases, the block stripe 310 can include multiple portions (e.g., blocks and/or pages) that are stored across different memory components of the set of memory components 112A to 112N. Namely, a first portion of the block stripe 310 can be stored on a first memory die and a second portion of the block stripe 310 can be stored on a second memory die. The media operation component 240 can simultaneously read each of the portions or can read the portions sequentially.

The media operation component 240 can read a first portion 312 (e.g., a first page or first block) of the block stripe 310. The first portion 312 can be stored at least in part on a first memory component of the set of memory components 112A to 112N. The media operation component 240 can provide the first portion 312 to a decoder which can be implemented by the error count component 230. The error count component 230 can decode the first portion 312 can count how many bit errors are encountered during decoding of the first portion 312. The error count component 230 can also count how many uncorrectable errors are present in the first portion 312.

In some cases, the first portion 312 can include multiple codewords (CWs). The error count component 230 can determine that a first CW of the first portion 312 is decoded with a first number of errors. The error count component 230 can compare the first number of errors to a maximum number of errors threshold (e.g., a bit error count threshold). In response to determining that the first number of errors transgresses the maximum number of errors threshold, the error count component 230 can increment a current counter of errors associated with the first portion 312 being decoded. The error count component 230 can then determine that a second CW of the first portion 312 is decoded with a second number of errors. In response to determining that the second number of errors fails to transgress the maximum number of errors threshold, the error count component 230 can prevent incrementing the current counter of errors associated with the first portion 312 being decoded.

After decoding each codeword of the first portion 312, the error count component 230 can access a first count 320 representing a total number of errors in the block stripe 310. The error count component 230 can increment or update the first count 320 by the current counter of errors that was generated while decoding CWs of the first portion 312. The error count component 230 can determine that the first portion 312 is stored on the first memory die. In response, the error count component 230 can access a first component error count 330 (e.g., a second count) associated with the first memory die. The error count component 230 can increment or update the first component error count 330 by the current counter of errors that was generated while decoding CWs of the first portion 312.

The media operation component 240 determines whether there are additional portions that need to be read/decoded from the block stripe 310. For example, the media operation component 240 can determine that the block stripe 310 includes a second portion 314. In response, the media operation component 240 can read the second portion 314 (e.g., a second page or second block) of the block stripe 310. The second portion 314 can be stored at least in part on a second memory component (e.g., second memory die) of the set of memory components 112A to 112N. The media operation component 240 can provide the second portion 314 to a decoder which can be implemented by the error count component 230. The error count component 230 can decode the second portion 314 can count how many bit errors are encountered during decoding of the second portion 314. The error count component 230 can also count how many uncorrectable errors are present in the second portion 314.

In some cases, the second portion 314 can include multiple codewords (CWs). The error count component 230 can determine that a first CW of the second portion 314 is decoded with a third number of errors. The error count component 230 can compare the third number of errors to the maximum number of errors threshold. In response to determining that the third number of errors transgresses the maximum number of errors threshold, the error count component 230 can increment a current counter of errors (which was reset to 0 after the first portion 312 finished being decoded) associated with the second portion 314 being decoded.

After decoding each codeword of the second portion 314, the error count component 230 can access the first count 320 representing a total number of errors in the block stripe 310. The error count component 230 can increment or update the first count 320 by the current counter of errors that was generated while decoding CWs of the second portion 314. The error count component 230 can determine that the second portion 314 is stored on the second memory die. In response, the error count component 230 can access a second component error count 332 (e.g., a second count) associated with the second memory die. The error count component 230 can increment or update the second component error count 332 by the current counter of errors that was generated while decoding CWs of the second portion 314. Similar operations can be performed for a third portion 316 of the block stripe 310 and the corresponding third component error count 334.

In some examples, the media operation component 240 determines that there remain no additional portions of the block stripe 310 to read/decode. In response, the media operation component 240 accesses the configuration data 220 to obtain a per die error count threshold and a block stripe error count threshold. The media operation component 240 can compare the first count 320 to the block stripe error count threshold. In response to determining that the first count 320 transgresses the block stripe error count threshold, the media operation component 240 can refresh or fold the data stored in the block stripe 310. The media operation component 240 can also compare each of the first component error count 330, second component error count 332, and corresponding third component error count 334 to respective per die error count thresholds. The media operation component 240 can refresh or fold the data stored in the block stripe 310 if any of these values transgresses the respective per die error count threshold. For example, the media operation component 240 can determine that the first component error count 330 transgresses a corresponding per die threshold associated with the first memory component. In such cases, the media operation component 240 can fold or refresh the data stored in the block stripe 310. If the first count 320 fails to transgress the block stripe error count threshold and if the first component error count 330, second component error count 332, and the corresponding third component error count 334 fail to transgress the respective per die error count thresholds, the media operation component 240 prevents folding or refreshing the block stripe 310 even though there exist portions with bit errors that transgress the maximum number of errors threshold.

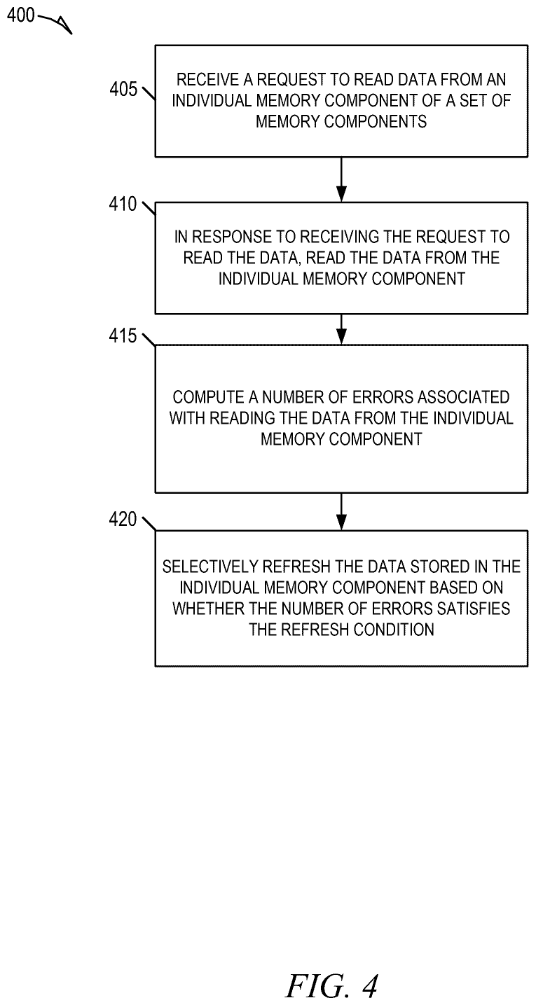

FIG. 4 is a flow diagram of an example method 400 to perform media management operations, in accordance with some examples. The method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 400 is performed by the media operations manager 122 of FIG. 1 Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 4, the method (or process) 400 begins at operation 405, with a media operations manager 122 of a memory sub-system 110 receiving a request to read data from an individual memory component of a set of memory components. At operation 410, the media operations manager 122 of the memory sub-system 110 in response to receiving the request to read the data, reads the data from the individual memory component. Thereafter, at operation 415, the media operations manager 122 computes a number of errors associated with reading the data from the individual memory component and, at operation 420, selectively refreshes the data stored in the individual memory component based on whether a number of errors satisfies the refresh condition.

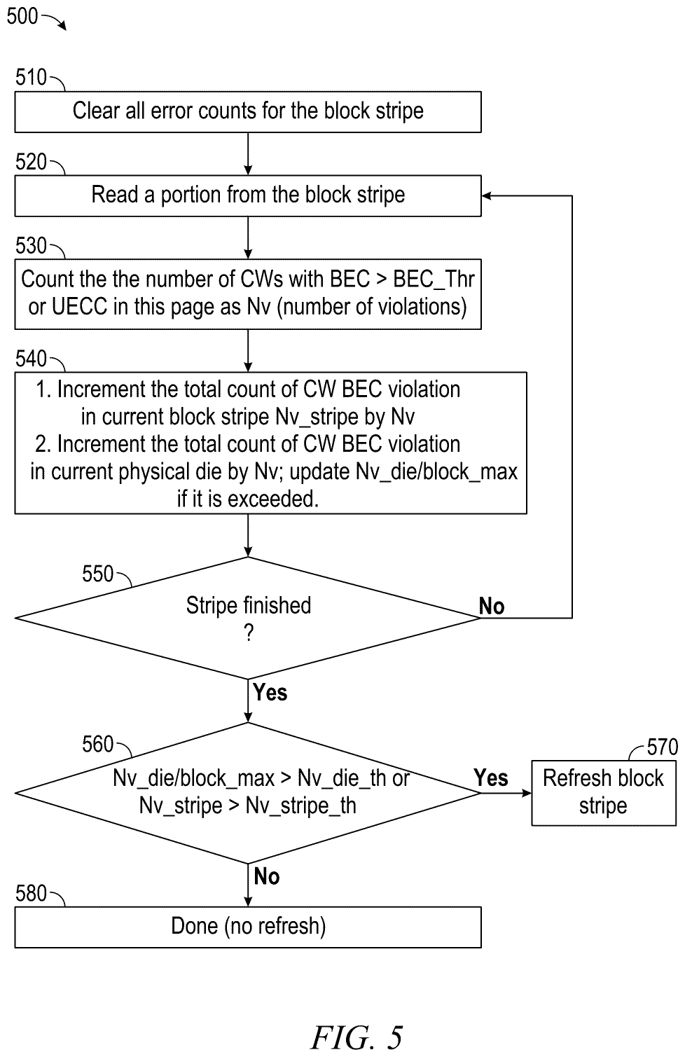

FIG. 5 is a flow diagram of an example method 500 to perform media management operations, in accordance with some examples. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 500 is performed by the media operations manager 122 of FIG. 1 Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 5, the method (or process) 500 begins at operation 510 where the media operations manager 200 (e.g., the firmware of the memory sub-system 110) selects a block stripe to analyze for whether to refresh the data and clears counters or count values associated with the block stripe. The media operations manager 200, at operation 520, reads data stored in a first portion of the block stripe, such as a first page. The media operations manager 200 counts the number of codewords in the first page for which a bit error count transgresses a threshold bit error count value at operation 530. For example, the first page may include several codewords. As each codeword is decoded, a bit error count is generated. If that bit error count transgresses the threshold bit error count or if the codeword includes uncorrectable errors, the media operations manager 200 updates a count representing number of codewords with bit error counts that transgress the threshold bit error count value.

At operation 540, the media operations manager 200 accesses a first count corresponding to a total count of the number of codewords in the block stripe having bit error counts that transgress the threshold bit error count or codewords includes uncorrectable errors. The media operations manager 200 updates the first count based on the number of codewords in the first page for which the bit error count transgresses the threshold bit error count value or which contain uncorrectable errors. The media operations manager 200 also identifies an individual memory component (e.g., memory die and/or memory block) of the set of memory components 112A to 112N in which the first page is stored and updates a second count associated with the individual memory component (e.g., block or memory die). The second count is specific to the memory component and tracks the number of codewords stored in the memory component that include error counts that transgress the threshold bit error count or that have uncorrectable errors. In some cases, the second count can be incremented by the number of codewords stored in the memory component that include error counts that transgress the threshold bit error count or that have uncorrectable errors. The second count can be updated if it is exceeded.

Then, at operation 550, the media operations manager 200 determines whether additional portions (e.g., pages) of the block stripe remain to be read and decoded. The media operations manager 200 proceeds to operation 520 to read a second portion of the block stripe if there remain additional portions to read and decode. The media operations manager 200 proceeds to operation 560 if no additional portions remain to be read and decoded for the block stripe. The media operations manager 200, at operation 560, compares the first count to a first threshold and the second count to a second threshold. The media operations manager 200 performs operation 570 to refresh or fold the block stripe in response to determining that the first count transgresses the first threshold and/or in response to determining that the second count transgresses the second threshold. The media operations manager 200 prevents folding or refreshing the block stripe at operation 580 in response to determining that the first count fails to transgress the first threshold and in response to determining that the second count fails to transgress the second threshold.

In view of the disclosure above, various examples are set forth below. It should be noted that one or more features of an example, taken in isolation or combination, should be considered within the disclosure of this application.

Example 1. A system comprising: a set of memory components of a memory sub-system; and a processing device operatively coupled to the set of memory components, the processing device being configured to perform operations comprising: receiving a request to read data from an individual memory component of the set of memory components; in response to receiving the request to read the data, reading the data from the individual memory component; computing a number of errors associated with reading the data from the individual memory component; determining whether the number of errors satisfies a refresh condition; and selectively refreshing the data stored in the individual memory component based on whether the number of errors satisfies the refresh condition.

Example 2. The system of Example 1, the operations comprising: reading the data from a first portion of an individual stripe stored across a plurality of memory components of the set of memory components.

Example 3. The system of Example 2, the operations comprising: storing a first count representing a total number of errors in the data stored across the individual stripe.

Example 4. The system of Example 3, the operations comprising: storing a second count representing a total number of errors associated with each memory component of the set of memory components.

Example 5. The system of Example 4, the operations comprising: determining that one or more errors of the number of errors associated with reading the data occurred in the first portion of the individual stripe stored in a first memory component of the set of memory components; and in response to determining that the one or more errors occurred in the first portion of the individual stripe stored in the first memory component of the set of memory components, incrementing the second count.

Example 6. The system of Example 5, the operations comprising: computing how many codewords in the first portion is associated with a bit error count that transgresses a bit error count threshold or have uncorrectable errors; incrementing the first count based on a quantity of the codewords in the first portion that is associated with the bit error count that transgresses the bit error count threshold or have uncorrectable errors.

Example 7. The system of Example 6, the operations comprising: determining whether all portions of the individual stripe have been read; and in response to determining that less than all portions of the individual stripe have been read, reading data from a second portion of the individual stripe.

Example 8. The system of Example 7, the operations comprising: updating the first count and the second count based on a quantity of errors that transgresses an error threshold associated with reading data from a second portion of the individual stripe.

Example 9. The system of any one of Examples 7-8, the operations comprising: determining that all portions of the individual stripe have been read.

Example 10. The system of Example 9, the operations comprising: determining that the second count transgresses a die count threshold in response to determining that all portions of the individual stripe have been read; and in response to determining that the second count transgresses the die count threshold, determining that the refresh condition has been satisfied.

Example 11. The system of Example 10, the operations comprising: refreshing the data stored in the individual memory component in response to determining that the refresh condition has been satisfied.

Example 12. The system of any one of Examples 10-11, the operations comprising: determining that the first count transgresses a stripe count threshold; and in response to determining that the first count transgresses the stripe count threshold, determining that the refresh condition has been satisfied.

Example 13. The system of Example 12, the operations comprising: refreshing the data stored in the individual memory component in response to determining that the refresh condition has been satisfied.

Example 14. The system of any one of Examples 1-13, wherein the number of errors represent a bit error count associated with one or more portions of the data stored in the individual memory component.

Example 15. The system of any one of Examples 1-14, wherein the number of errors represent an uncorrectable bit errors associated with one or more portions of the data stored in the individual memory component.

Example 16. The system of any one of Examples 1-15, the operations comprising: preventing refreshing the data stored in the individual memory component in response to determining that the number of errors fails to satisfy the refresh condition.

Example 17. The system of any one of Examples 1-16, wherein refreshing the data comprises folding the data.

Methods and computer-readable storage medium with instructions for performing any one of the above Examples.

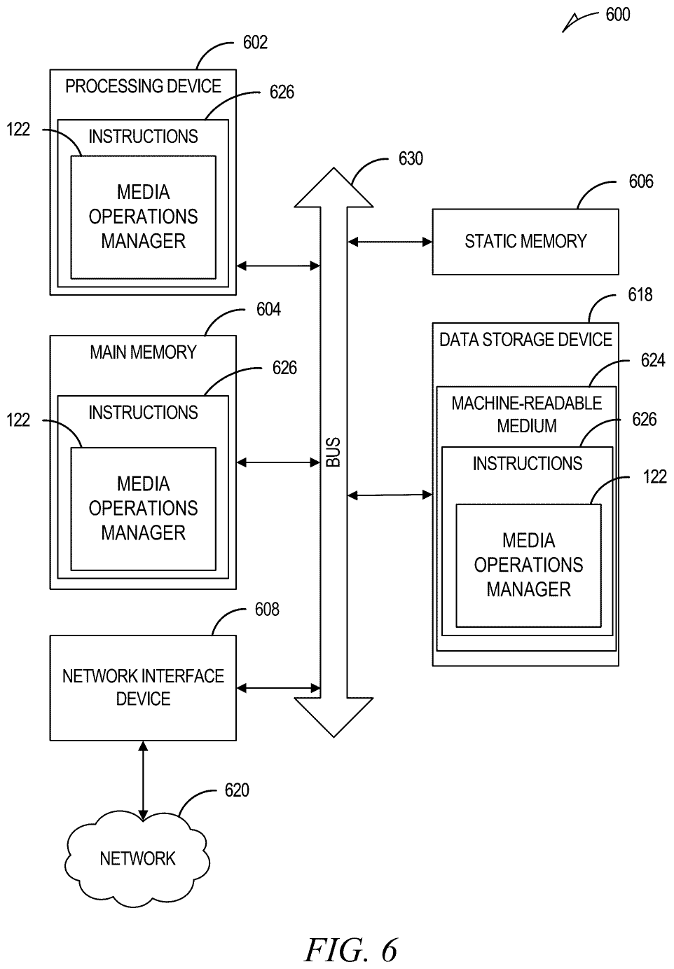

FIG. 6 illustrates an example machine in the form of a computer system 600 within which a set of instructions can be executed for causing the machine to perform any one or more of the methodologies discussed herein. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application specific integrated circuit (A SIC), a field programmable gate array (FPGA), a digital signal processor (DSP), a network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1

In one embodiment, the instructions 626 implement functionality corresponding to the media operations manager 122 of FIG. 1 While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMs); erasable programmable read-only memories (EPROMs); EEPROMS; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, examples of the disclosure have been described with reference to specific example embodiments thereof. It will be evident that various modifications can be made thereto without departing from the broader examples of the disclosure as set forth in the following claims. The specification and drawings are, accordingly, to be regarded in an illustrative sense rather than a restrictive sense.

What is claimed is:

1. A system comprising:
a set of memory components of a memory sub-system; and
a processing device operatively coupled to the set of memory components, the processing device being configured to perform operations comprising:
receiving a request to read data from an individual memory component of the set of memory components;
in response to receiving the request to read the data, reading the data from the individual memory component;
computing a number of errors associated with reading the data from the individual memory component;
determining whether the number of errors satisfies a refresh condition; and
selectively refreshing the data stored in the individual memory component based on whether the number of errors satisfies the refresh condition.

2. The system of claim 1, the operations comprising:
reading the data from a first portion of an individual stripe stored across a plurality of memory components of the set of memory components.

3. The system of claim 2, the operations comprising:
storing a first count representing a total number of errors in the data stored across the individual stripe.

4. The system of claim 3, the operations comprising:
storing a second count representing a total number of errors associated with each memory component of the set of memory components.

5. The system of claim 4, the operations comprising:
determining that one or more errors of the number of errors associated with reading the data occurred in the first portion of the individual stripe stored in a first memory component of the set of memory components; and
in response to determining that the one or more errors occurred in the first portion of the individual stripe stored in the first memory component of the set of memory components, incrementing the second count.

6. The system of claim 5, the operations comprising:
computing how many codewords in the first portion is associated with a bit error count that transgresses a bit error count threshold or have uncorrectable errors; and
incrementing the first count based on a quantity of the codewords in the first portion that is associated with the bit error count that transgresses the bit error count threshold or have uncorrectable errors.

7. The system of claim 6, the operations comprising:
determining whether all portions of the individual stripe have been read; and
in response to determining that less than all portions of the individual stripe have been read, reading data from a second portion of the individual stripe.

8. The system of claim 7, the operations comprising:
updating the first count and the second count based on a quantity of errors that transgresses an error threshold associated with reading data from a second portion of the individual stripe.

9. The system of claim 7, the operations comprising:
determining that all portions of the individual stripe have been read.

10. The system of claim 9, the operations comprising:
determining that the second count transgresses a die count threshold in response to determining that all portions of the individual stripe have been read; and
in response to determining that the second count transgresses the die count threshold, determining that the refresh condition has been satisfied.

11. The system of claim 10, the operations comprising:
refreshing the data stored in the individual memory component in response to determining that the refresh condition has been satisfied.

12. The system of claim 10, the operations comprising:
determining that the first count transgresses a stripe count threshold; and
in response to determining that the first count transgresses the stripe count threshold, determining that the refresh condition has been satisfied.

13. The system of claim 12, the operations comprising:
refreshing the data stored in the individual memory component in response to determining that the refresh condition has been satisfied.

14. The system of claim 1, wherein the number of errors represent a bit error count associated with one or more portions of the data stored in the individual memory component.

15. The system of claim 1, wherein the number of errors represent an uncorrectable bit error associated with one or more portions of the data stored in the individual memory component.

16. The system of claim 1, the operations comprising:
preventing refreshing the data stored in the individual memory component in response to determining that the number of errors fails to satisfy the refresh condition.

17. The system of claim 1, wherein refreshing the data comprises folding the data.

18. A method comprising:
receiving a request to read data from an individual memory component of a set of memory components;
in response to receiving the request to read the data, reading the data from the individual memory component;
computing a number of errors associated with reading the data from the individual memory component;
determining whether the number of errors satisfies a refresh condition; and
selectively refreshing the data stored in the individual memory component based on whether the number of errors satisfies the refresh condition.

19. The method of claim 18, comprising:
reading the data from a first portion of an individual stripe stored across a plurality of memory components of the set of memory components.

20. A non-transitory computer-readable storage medium comprising instructions that, when executed by a processing device, cause the processing device to perform operations comprising:
receiving a request to read data from an individual memory component of a set of memory components;
in response to receiving the request to read the data, reading the data from the individual memory component;
computing a number of errors associated with reading the data from the individual memory component;
determining whether the number of errors satisfies a refresh condition; and
selectively refreshing the data stored in the individual memory component based on whether the number of errors satisfies the refresh condition.
